(19) United States
(12) Patent Application Publication
(10) Pub. No.: US 2025/0324249 A1
(43) Pub. Date: Oct. 16, 2025

(54) CONTENT AUTHENTICITY MOBILE DEVICE AND METHOD FOR AUTHENTICATING MEDIA CONTENT

(71) Applicant: NEC Corporation Of America, Herzlia (IL)

(72) Inventors: Tsvi LEV, Tel-Aviv (IL); Yaacov HOCH, Ramat-Gan (IL)

(73) Assignee: NEC Corporation Of America, Herzlia (IL)

(21) Appl. No.: 18/631,155

(22) Filed: Apr. 10, 2024

(51) Int. Cl. H04W 12/06; G06V 20/00; G10L 15/25; G10L 25/24; G10L 25/51; H04W 12/106; H04W 12/61; H04W 12/63

(52) U.S. Cl. CPC H04W 12/06; G06V 20/95; G10L 15/25; G10L 25/24; G10L 25/51; H04W 12/106; H04W 12/61; H04W 12/63

(57) ABSTRACT

Content authenticity mobile devices, systems and methods for authenticating media content in real-time. The device captures media content using sensors and generates a unique visual digital signature by signing the content with a key and recording time and optionally geographic coordinates and/or movement data. This signature is displayed on the device's screen and recorded alongside the content, serving as a tamper-evident seal. The authentication method involves extracting the visual signature and comparing it with the recorded content to verify its authenticity. The system may generate digital certificates reflecting the authenticity status of the content, which can be stored with the content and easily verified by third parties.

### FIELD AND BACKGROUND OF THE INVENTION

The present invention relates to the field of media content authentication and more specifically to methods and systems for authenticating the origin and integrity of media content using a content authenticity mobile device.

In the digital age, media content such as audio and video recordings can be easily created, modified, and distributed. This ease of manipulation and falsified media data creation has led to challenges in verifying the authenticity and origin of media content. Conventional methods for authenticating media, such as digital watermarking or cryptographic signatures, often require specialized software or hardware and can be complex to implement.

Moreover, these methods often rely on the originator or creator of the media to be part of the authentication scheme. For example, if a citizen captures a video of a politician speaking in public and saying something controversial, the citizen may not have the necessary signing capability or may not be considered a trusted source. This limitation can make it difficult to verify the authenticity of media content captured by individuals who are not part of a trusted network or do not have access to specialized authentication tools.

### SUMMARY OF THE INVENTION

According to an aspect of some embodiments of the present invention there are provided a content authenticity mobile device and method for authenticating media content. In one aspect, the mobile device includes a sensor for recording a media signal of a speaker expressing verbal information, a display, and a processor. The processor generates visual content by signing the media signal with a unique key, such as a private key, of the device and recording time of the media signal and instructs the display to render this visual content, thereby digitally signing the recorded content.

In another aspect, a method for authenticating media content includes receiving a recording depicting a speaker and a content authenticity mobile device, such as the content authenticity mobile device described herein, extracting verbal information expressed by the speaker and media content displayed on the device, decoding the displayed media content based on a key, such as a public key associated with a private key used for the encoding, and the recording time, and authenticating the recording by matching the verbal information with the decoded media content.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic diagram of a content authenticity mobile device for generating a real time signature, according to some embodiments of the present invention;

FIG. 2 is schematic diagram of a content authenticity mobile device implemented by smartphone hardware, according to some embodiments of the present invention;

FIGS. 3A-B are schematic diagrams of a system for authenticating media content, according to some embodiments of the present invention;

FIG. 4 is a flow diagram illustrating a method for digitally signing content using a content authenticity mobile device, such as the device depicted in FIG. 1, according to an embodiment of the present invention; and

FIG. 5 is a flow diagram illustrating a method for authenticating media content, according to some embodiments of the present invention.

### DESCRIPTION OF SPECIFIC EMBODIMENTS OF THE INVENTION

The present invention relates to the field of media content authentication and more specifically to methods and systems for authenticating the origin and integrity of media content using a content authenticity mobile device.

There is a need for a simple, real-time method for authenticating media content that does not require modifying the original data or relying on external systems. At least some embodiments of the invention address this need by providing a content authenticity mobile device and method that integrates sensor data, timestamps, and location information to create a unique, visual digital signature that is displayed on the device and captured alongside the subject of the recording.

The present invention, in some embodiments thereof, relates to a content authenticity mobile device equipped with sensors (e.g., microphone, camera) to capture media content, a display to render visual content, and a processor to generate a unique visual digital signature by signing the captured content with a key and recording time (e.g. a timestamped key), geographic coordinates, and movement data. The visual signature is displayed on the device's screen and recorded alongside the content. The device enables real-time, tamper-evident authentication of media content at the point of capture, leveraging the capabilities of modern smartphones for widespread adoption and case of use.

The present invention, in some embodiments thereof, relates to a method for authenticating media content. The method involving receiving a recording that includes a depiction of a speaker and the display of the content authenticity mobile device, extracting verbal information and displayed media content from the recording, decoding the media content based on the recording time and a decryption value such as a public key associated with the private key used for the encoding of the displayed media content, and authenticating the recording by matching the verbal information with the decoded media content. This method provides a reliable and efficient way to verify the authenticity of media content by comparing the embedded visual signature with the content itself, reducing the risk of tampering and manipulation.

The present invention, in some embodiments thereof, relates to a system for authenticating media content. The system includes a service with a network interface for receiving recordings and one or more processors for extracting information from the recordings, decoding the displayed media content, and authenticating the recordings by matching the extracted verbal information with the decoded media content. The system enables the automation and scalability of the authentication process, allowing for the efficient verification of large volumes of media content from multiple sources.

Optionally, the content authenticity mobile device, incorporating additional features such as a network interface for acquiring timestamped keys, optionally a location module for providing geographic coordinates, and optionally a movement sensor for recording the speaker's movement during the recording. This provides additional layers of authentication and contextual information, enhancing the reliability and trustworthiness of the authenticated media content.

Optionally, the content authenticity mobile device. Method and/or system are used for digital certificate generation. A process of generating digital certificates that reflect the authenticity status of the media content, including details such as a hash of the content, timestamp, geographic coordinates, and digital signature of the authentication system. These certificates are stored along with the media content and can be easily verified by third parties. This provides a standardized and tamper-evident way to communicate the authenticity of media content, facilitating trust and credibility in digital media ecosystems.

Optionally, the content authenticity mobile device and authentication method may be easily integrated with existing technologies, such as smartphones, content management systems, and social media platforms, through the use of APIs, SDKs, and other standard interfaces. This facilitates the widespread adoption and deployment of the authentication technology, enabling its use across a wide range of applications and domains.

Also, as indicated above, known methods often rely on the originator or creator of the media to be part of the authentication scheme. To address this issue, there is a need for an authentication method that allows anyone to record and transmit media content, regardless of their equipment or ability to authenticate the content themselves. Such a method should enable the verification of the authenticity and integrity of the media content, even if the originator is unknown or untrusted. Embodiments of the present invention addresses this need by providing a content authenticity mobile device and method that enables anyone to digitally sign and authenticate media content at the point of capture, without requiring specialized software, hardware, or expertise (accept of the device which might be implemented as an application executed on a smartphone). The device integrates sensor data, timestamps, and optionally, geographic coordinates and movement data to create a unique digital signature that is embedded into the media content itself, providing a tamper-evident seal that can be verified by third parties.

By enabling anyone to digitally sign and authenticate media content at the point of capture, embodiments of the present invention democratizes the process of media authentication and empowers individuals to create verifiable records of events and statements, regardless of their technical capabilities or trustworthiness. This has significant implications for various applications, such as journalism, law enforcement, and social media, where the ability to verify the authenticity and origin of user-generated content is of critical importance.

The present invention, in some embodiments thereof, a digital signature service for authenticating a speaker's statements at a venue, without requiring the speaker to actively participate in the authentication process or carry a content authenticity mobile device. The digital signature service comprises a recording unit such as a directional microphone aimed at the speaker to capture verbal information, a processing unit to extract the verbal information and generate visual content by integrating the extracted verbal information with a digital signature associated with the venue, and a projection mechanism to project the generated visual content onto the speaker's body or clothing.

By projecting the visual content containing the digital signature onto the speaker, the digital signature service effectively embeds the authentication data into the visual environment. This ensures that any video or images captured by the audience will inevitably include the projected visual content, which serves as a tamper-evident and verifiable record of the speaker's statements.

The digital signature may be created using a private key associated with the venue's public key infrastructure (PKI), ensuring that the authentication data is cryptographically bound to the venue's credentials. The visual content can take the form of QR codes, time-modulated signals, or other machine-readable patterns, and may incorporate additional authentication data such as timestamps, location information, or event-specific identifiers.

To verify the authenticity of the speaker's statements, a verification system may be employed to receive captured video or images containing the projected visual content, extract the digital signature, and validate it using the venue's public key. If the digital signature is valid, the verification system can confirm the authenticity of the speaker's statements, proving that they have not been tampered with or altered. Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

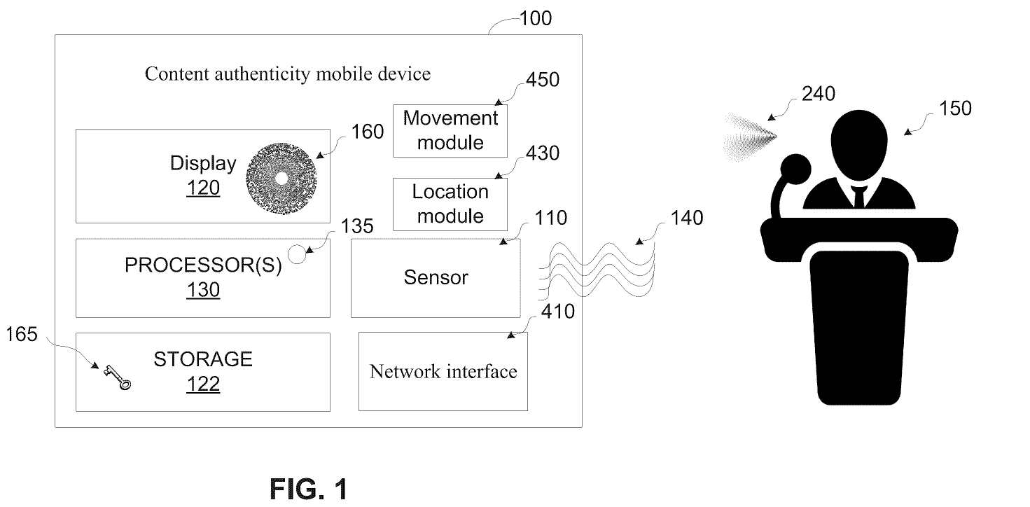

Referring now to the drawings, FIG. 1 illustrates a content authenticity mobile device 100 for adding a verifiable signature to media content documenting a scene wherein a speaker expresses content, according to some embodiments of the present invention. The mobile device 100 includes a sensor 110, a display 120, and a processor 130. The sensor 110 is configured to record a media signal 140 originated from a speaker 150 who is expressing verbal information in a language. The sensor 110 may be a microphone for recording an audio signal or a camera for recording a video signal documenting the speaker's lip movements.

The display 120 is configured to render visual content 160 generated by the processor 130. The display 120 may be any suitable type of display technology, such as an LCD, OLED, any time of visual content projector, or e-ink display. The visual content 160 is optionally visible spatiotemporal changing signature that allows authenticating content expressed by the speaker in the scene at the time the media signal 140 was recorded.

The processor 130 is configured to generate the visual content 160 by signing a recording of the media signal 140 with a key and a recording time of the media signal 140. The key maybe locally stored, such as 165, or acquired from an external source. Optionally, a timestamped key may be generated locally by the processor 130 or a designated hardware such as an internal clock 135 or acquired from an external source via a network interface 410 configured to acquire the timestamped key via a network and used for the signing. The network interface 410 may be any suitable wireless or wired communication interface, such as Wi-Fi, Bluetooth, or cellular.

The signing of the media signal 140 with key and time, for instance with a timestamped key, may be performed using various methods, such as encoding the timestamped key into the media signal 140 using steganography or cryptographic techniques. Alternatively, the visual content 160 may include a visual representation of the media signal 140 (e.g., a spectrogram or waveform) displayed alongside the timestamped key.

In use, the processor 130 instructs the display 120 to render the generated visual content 160, thereby digitally signing the content that visually documents the speaker 150 expressing the verbal information. This digital signature serves to authenticate a recording depicting the recorded media signal 140 and documenting information according to which the visual content 160 is created.

In some embodiments, the processor 130 may execute an application stored in storage 122 to generate the visual content 160 also based on additional data, such as geographic coordinates of the environment in which the mobile device 100 is located. These geographic coordinates may be received from a location module 430, such as a GPS receiver, as a one-time code. In particular, the processor 130 of the mobile device 100 generates the visual content 160 also based on geographic coordinates of the environment in which the mobile device is located. The geographic coordinates may be obtained from a location module 430, such as a GPS receiver, and integrated into the visual content 160 to provide additional context and authentication. The geographic coordinates may be received as a one-time code from the location module 430. This one-time code ensures that the geographic coordinates 420 are unique to the specific time and location of the recording and cannot be reused or replicated

The mobile device 100 may also include a movement sensor 450 configured to record the movement of the speaker 150 while expressing the verbal information. The processor 130 may integrate this movement data into the generated visual content 160 to provide additional context and authentication. Suitable movement sensors include accelerometers, inertial measurement units (IMUs), magnetometers, and gyroscopes. In use, the mobile device 100 may be used to capture gestures, facial expressions, or other movements of the speaker 150 that are recorded as time syncretized metadata that documents the recorded movement for authentication of the recorded media signal 140, for example as described below.

The generated visual content 160 is displayed on the display 120 of the content authenticity mobile device 100 in real-time during the recording session. The visual content 160 may be displayed at any machine-readable format that can be easily captured and processed by the authentication system, for instance a dynamically changing QR code, barcode, or any other spatiotemporal changing marking. The layout and design of the visual content 160 may vary depending on the specific application and use case. For example, the visual content 160 may be displayed as a translucent overlay on top of displayed content, allowing the user to see both the visual content and another content such as a copy of the subject being recorded. Alternatively, the visual content 160 may be displayed all over the display or in a dedicated area of the screen, such as a corner or bottom bar.

The visual content 160 is continuously updated throughout the recording session based on the current timestamp, changes in the current recorded media, and optionally changes in location, orientation, and/or motion data. This ensures that the visual content 160 remains synchronized with the recorded media signal 140 to later provide a complete and accurate signature of the recording context and optionally identification of when the recorded content may have been tempered. By generating and displaying the visual content 160 in real-time during the recording session, the content authenticity mobile device 100 creates a tamper-evident link between the recorded media signal 140 and the authentication data at different time points during the recording, making it possible to verify the authenticity and integrity of the recording at multiple recording points at a later time.

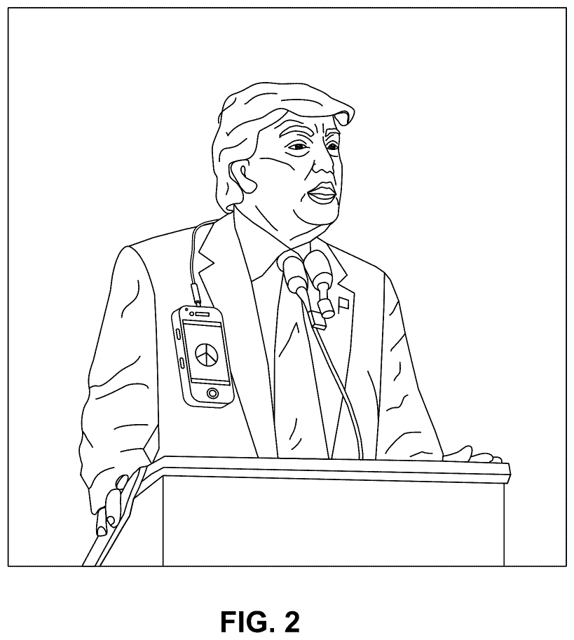

In a preferred embodiment, for example as depicted in FIG. 2, the content authenticity mobile device 100 is a smartphone device, taking advantage of the various sensors, displays, and processing capabilities commonly available in modern smartphones. However, the invention may be implemented on any suitable mobile device platform, such as a designated device, a smartwatch, a smart ornament or clothing and/or the like.

The content authenticity mobile device 100 provides a simple and efficient way to authenticate media content in real-time by generating a unique visual digital signature that is displayed on the device and recorded alongside the subject of the media content. This visual digital signature integrates sensor data, timestamps, and optionally geographic coordinates to create a tamper-proof record of the content's origin and integrity.

Optionally, the processor of the content authenticity mobile device 100 executes a user interface to provide a user-friendly and intuitive interface that allows users to easily capture, authenticate, and manage their recorded media signals 140. The user interface maybe part of an application executed on the content authenticity mobile device, facilitating a display of a live preview of the camera feed, along with controls for starting and stopping the recording. The user can tap the record button to begin capturing the media signal 140, and tap it again to stop the recording. The device provides clear visual and haptic feedback to indicate when the recording is in progress and when it has been saved.

During the recording, the device 100 displays the visual content 160 that is being generated and embedded with the timestamped key 170, and optionally with geographic coordinates and/or movement data as described herein.

The application may render a settings screen that allows the user to configure various aspects of the device's behavior and functionality. For example, the user can choose whether to enable or disable the embedding of geographic coordinates or movement data, or can set a preferred resolution or frame rate for the recorded media signal. In addition to the recording and settings screens, the device also provides a gallery view that allows the user to browse and manage their previously recorded media signals. The gallery view displays thumbnails of each recording, along with metadata such as the date, time, and location of the recording. The user can tap on a thumbnail to view the full recording and its associated authentication data. The device provides a playback interface that allows the user to watch the recording, view the embedded visual content 160, and verify the authenticity of the recording using the device's authentication features.
To ensure the security and privacy of the user's recordings and personal data, the device may require the user to authenticate themselves using a biometric or password-based authentication mechanism before accessing the device's features and data. The device also includes a secure lockscreen that prevents unauthorized access to the device when it is not in use.

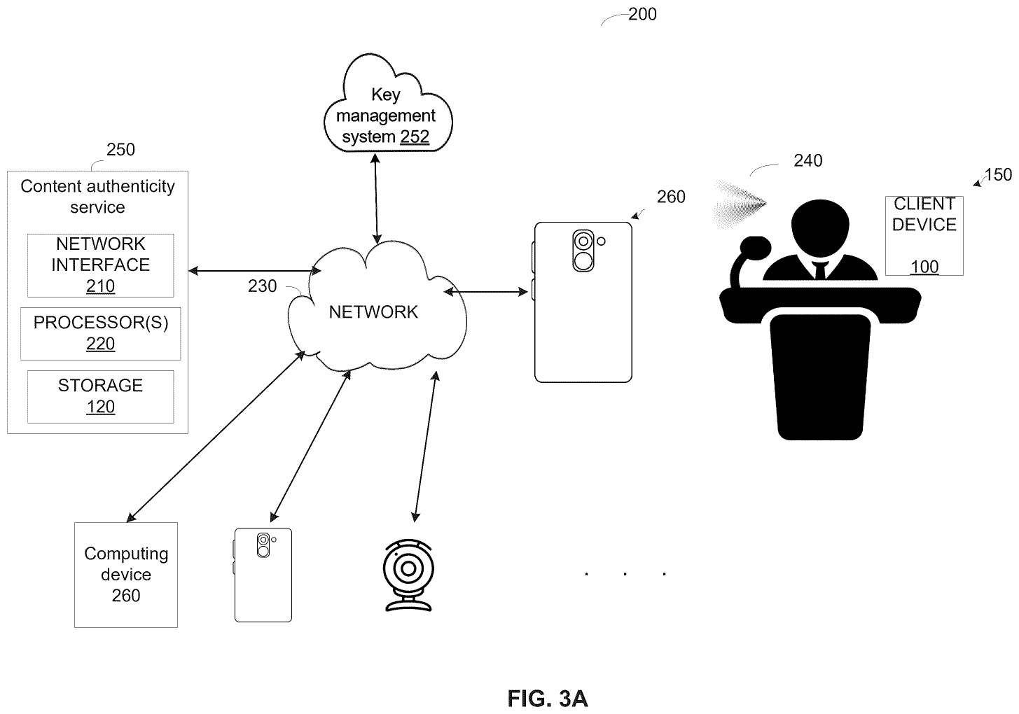

Reference is also made to FIG. 3A which illustrates a system 200 having a service 250 for authenticating media content, for example executed on a server, a virtual machine, or a virtual server and one or more content authenticity mobile devices 100, for instance as described above, according to an embodiment of the present invention. The service 250 is optionally a server 205 having a network interface 210 and one or more processors 220.

The network interface 210 is configured to receive over a network connection 230 from a network connected device 260 a recording that includes a depiction of a speaker 150 and a content authenticity mobile device, such as 100 in FIG. 1, located in proximity to the speaker 150. The recording received via the network connection 230 may be received from various network connected devices 260, such as smartphones, security cameras, computing units, servers, or by any web-based submission.

The one or more processors 220 are configured to execute code for performing various operations on the received recording. These operations include extracting verbal information expressed by the speaker 150 in a language and media content displayed on the display 120 of the content authenticity mobile device 100.

The verbal information may be extracted using audio analysis techniques, such as speech recognition, to convert the speech in the recording to text or other formats suitable for comparison. The media content 160 may be extracted using image analysis techniques, such as machine vision, used to identify and isolate the displayed content from the recording 230.

The processors 220 are further configured to decode the extracted media content 160 based on a recording time of the recording 230. This decoding process may involve using the recording time to retrieve a corresponding timestamped key that was used by the content authenticity mobile device 100 to generate the displayed media content 160 or any other time-based key.

Optionally, the content authenticity mobile device 100 generates the unique timestamped key for each recording session. The timestamped key links the recorded media signal 140 or extracted media content 160 with a specific time and device. The timestamped key may be generated by the processor 130 using a secure key generation algorithm, such as a cryptographic hash function (e.g., SHA-256) or a symmetric key algorithm (e.g., AES). The input to the key generation algorithm includes a unique device identifier (e.g., device serial number or MAC address), the current timestamp, and a random nonce value to ensure the uniqueness of each key. The generated timestamped key is securely associated with the corresponding recording session. The key 170 may be stored in a secure element, trusted platform module (TPM), or other tamper-resistant storage to prevent unauthorized access or modification.

In some embodiments, the timestamped key may be generated by an external key management system 252 and securely transmitted to the content authenticity mobile device 100 via the network interface. In such embodiments, the content authenticity mobile device 100 may utilize the external key management system 252 to securely store and manage the keys used for decoding the visual content 160 embedded in the recorded media. The external key management system 600 is a separate entity from the content authenticity mobile device 100 and the authentication system 200, and is responsible for providing access to the decoding keys. Each decoding key stored in the external key management system 600 may be uniquely associated with a specific device, such as the content authenticity mobile device 100.

In one implementation, the external key management system 252 utilizes a public-key cryptography scheme, where each device is assigned a pair of keys: a public key and a private key. The public key is freely distributable and can be used by the external key management system to encrypt the decoding keys before transmitting them to the requesting device. The private key, on the other hand, is kept securely by device 100 and is used also to decrypt the encoded decoding keys received from the external key management system 252.

The decoding keys stored in the external key management system 252 may be timestamped based on the recording time of the respective media they are used to decode. This means that each decoding key is specific to a particular moment or time interval, allowing for targeted decoding of the visual content 160.

When a client requires a decoding key to authenticate a specific portion of the recorded media, it sends a request to the external key management system 252. The request may include the recording time of the media and any other necessary authentication parameters to identify the key. Upon receiving the request, the external key management system 252 may verify authenticity of the requesting device and checks if the device is authorized to access the requested decoding key. If the verification is successful, the external key management system 252 retrieves the appropriate decoding key based on the provided recording time and data above the respective encoded media.

The decoding key may be transmitted securely to the requesting device, which uses its to decode the visual content 160 embedded in the recorded media, enabling the authentication process to proceed. The decoding key may also be encrypted.

The external key management system 252 can be implemented using various key management protocols and standards, such as the Key Management Interoperability Protocol (KMIP) or the Public-Key Cryptography Standards (PKCS). It can be hosted on secure servers or cloud platforms, and can be accessed by the content authenticity mobile device 100 and any other device through secure network connections and APIs. For example, the device 100 may send a request to the key management system at the start of each recording session, including the device identifier and current timestamp. The key management system generates the timestamped key 170 and sends it back to the device 100 over a secure communication channel, such as HTTPS or SSL/TLS.

The content authenticity mobile device 100 may also implement key rotation or key expiration policies to limit the lifespan of each timestamped key. For example, keys may be set to expire after a certain period (e.g., 24 hours) or after a certain number of uses. Expired keys are securely deleted from the device 100 and cannot be used for future authentication.

By generating a unique, secure, and time-bound key for each recording session, the content authenticity mobile device 100 ensures that the recorded media signal 140 can be reliably linked to a specific time and device, providing a strong foundation for the authentication process.

Once the media content 160 has been decoded, the processors 220 may execute a code for authenticating the recording by matching the verbal information 240 extracted from the recording with the decoded media content 160 displayed on the content authenticity mobile device 100 in the recording. This matching process may involve comparing the text or other format of the verbal information 240 with the decoded media content 160 to determine if they are consistent.

The authentication process may involve additional steps or techniques, such as comparing the time and location of the recording with the time and location encoded in the media content 160, or analyzing the movement of the speaker 150 in the recording 230 to ensure it matches any movement data encoded in or in association with the media content 160.

If the extracted verbal information 240 and decoded media content 160 match, the recording 230 is considered authenticated, indicating that the content of the recording has not been altered or fabricated since it was originally captured. If the information does not match, the recording 230 is considered unauthenticated and may be flagged for further review or rejection.

Optionally, the authentication process may involve a more granular analysis of the recording, allowing for the identification of specific segments or time frames where the verbal information extracted from the recording does not match the decoded media content displayed on the content authenticity mobile device. This partial authentication capability enables a more nuanced and precise assessment of the recording's authenticity, rather than a simple binary classification of the entire recording as authentic or inauthentic.

For example, consider a recording that is two minutes long, where the content authenticity mobile device has been used to generate and display a unique visual digital signature throughout the recording. During the authentication process, the system may analyze the recording in smaller time increments, such as second-by-second or frame-by-frame, comparing the extracted verbal information with the decoded media content at each increment.

In this scenario, the system may determine that the verbal information and the decoded media content match perfectly for the majority of the recording, indicating that those segments are authentic and have not been altered or manipulated. However, the system may also identify a specific segment, such as the time frame between second 45 and second 50, where there is a mismatch between the extracted verbal information and the decoded media content.

This mismatch could indicate that the specific segment of the recording has been tampered with, edited, or manipulated in some way, while the rest of the recording remains authentic. The authentication system can flag this segment as potentially inauthentic and provide detailed information about the nature and extent of the mismatch.

The ability to authenticate recordings at a more granular level offers several benefits. It allows for a more accurate and precise assessment of the recording's authenticity, identifying specific areas of concern while still recognizing the overall authenticity of the majority of the content. This can be particularly valuable in scenarios where recordings may be edited or manipulated in subtle ways, or where the authenticity of specific statements or events within a larger recording is of critical importance.

Furthermore, the partial authentication capability can help to maintain the evidentiary value of recordings, even if small portions are found to be inauthentic. By isolating and flagging the specific segments that have been altered or manipulated, the system can help to preserve the credibility and reliability of the rest of the recording, rather than dismissing the entire recording as untrustworthy.

The authentication system can generate detailed reports or annotations that highlight the specific segments of the recording that have been authenticated or flagged as potentially inauthentic. These reports can include timestamps, descriptions of the mismatches detected, and any other relevant metadata or contextual information. This detailed output can be valuable for legal proceedings, investigations, or other situations where the authenticity and integrity of recordings are of critical importance.

Overall, the ability to partially authenticate recordings at a granular level, identifying specific segments or time frames where mismatches between the extracted verbal information and the decoded media content are detected, provides a more flexible, nuanced, and precise approach to media authentication. This capability enhances the utility and value of the content authenticity mobile device and the associated authentication system, enabling them to support a wider range of use cases and applications where the authenticity and integrity of recordings are paramount.

Optionally, a digital certificate is generated to reflect authenticated or non-authenticated content. For example, upon completion of the authentication process, the service 250 generates a digital certificate that reflects the authenticity status of the recorded media content. This digital certificate serves as a tamper-evident, cryptographically signed attestation of the content's authenticity, which can be easily verified by third parties. If the authentication process determines that the recorded media content is authentic and has not been tampered with, the system generates a digital certificate that includes a hash or fingerprint of the content, along with a timestamp, the geographic coordinates of the recording location, and other relevant metadata. The certificate is then signed using a private key associated with the authentication system, ensuring its integrity and non-repudiation. On the other hand, if the authentication process detects any signs of tampering, manipulation, or inconsistency in the recorded content or the associated authentication data, the system may generate a notice or a digital certificate that reflects the non-authenticity of the content. This certificate may include details about the specific issues or anomalies detected during the authentication process, as well as a timestamp and other relevant metadata. The digital certificate can be stored along with the recorded media content, either embedded within the content itself (e.g., as metadata or a watermark) or as a separate file. This allows the authenticity of the content to be easily verified by anyone who has access to the certificate and the corresponding public key of the authentication system.

The system 200 provides an efficient and automated way to authenticate media recordings by leveraging the content authenticity mobile device 100 to create a unique, tamper-proof digital signature that can be verified against the content of the recording itself. This system can be used in various applications, such as journalism, law enforcement, and social media, to ensure the integrity and origin of media content.

For example, such a system may be used by a journalist uses the content authenticity mobile device mounted on front of a camera recording a video interview with a key witness in a high-profile investigation. The content authenticity mobile device renders on its display media content 160 based on captured media, a timestamped key, and optionally geographic coordinates and/or movement data. Upon receiving the video depicting the interviewee and the device, an authentication service, such as 250, verifies the authenticity of the recording based on the matching described herein and generates a digital certificate that attests to its integrity. The certificate includes a hash of the video, the timestamp of the recording, the geographic coordinates of the location, and the digital signature of the authentication system. This certificate can be presented along with the video to provide strong evidence of its authenticity and to support the credibility of the journalist's investigation.

The use of digital certificates in the content authentication process provides a standardized and reliable way to communicate the authenticity status of media content to users, platforms, and other stakeholders. By generating certificates that are cryptographically signed and tamper-evident, the system ensures that the authenticity of the content can be easily verified and trusted, reducing the risk of misinformation and manipulation.

Furthermore, the inclusion of detailed metadata and evidence in the certificates allows for more nuanced and contextual assessments of the content's authenticity all along the recording, rather than a simple binary classification. This can help to support more informed decision-making and to facilitate the development of trust and credibility in digital media ecosystems.

The system is optionally provided as a Software as a service (SaaS) that allows various applications and/or mobile devices to connect to and use an authentication service over the Internet. In such a manner, the system may provide service to multiple different clients and device, optionally in parallel.

The system may leverage capabilities of modern smartphones to provide a cost-effective, flexible, and scalable solution for enhancing the trust and credibility of digital media across various applications, such as journalism, law enforcement, and social media, by enabling real-time, tamper-evident authentication of media content.

Reference is also made to FIG. 3B which illustrates a system 266 having the service 250 for authenticating media content as described with reference to FIG. 3A and a venue authenticity device 700 which functions as and instead of the above described content authenticity mobile devices 100, according to an embodiment of the present invention. In these embodiments, the digital signature device 700 can be employed to provide digital signatures for a speaker at a specific venue, without requiring the speaker to actively participate in the authentication process or carry a device such as the content authenticity mobile device 100. This service is particularly useful in situations where the speaker may not be aware of or consent to the verification process, but the venue or event organizers wish to ensure the authenticity and integrity of the speaker's statements.

The venue authenticity device 700 is optionally a processing unit 730 that includes processor(s) and a storage 740 and a recording unit 710, such as a directional microphone or a camera and a projection mechanism 720. The directional microphone or the camera 710 may be aimed at the speaker and is designed to capture the speaker's voice with high clarity and minimal background noise. It is connected to the processing unit 730 that analyzes the captured audio/video signal and extracts the verbal information expressed by the speaker, for instance as described with reference to the content authenticity mobile devices 100. The projection mechanism 720 is positioned in such a way that it can project visual content onto the speaker's body or clothing without causing significant distraction or discomfort. The visual content can take the form of QR codes, time-modulated signals, or other machine-readable patterns that can be easily captured by cameras or recording devices in the audience. Optionally, the projected visual content is encrypted as a watermark, optionally invisible to a naked eye.

The processing unit 730 of the venue authenticity device 700 generates the visual content by integrating the extracted verbal information from the speaker with a digital signature that uniquely identifies the venue or event. This digital signature is created as described with reference to the above described content authenticity mobile devices 100 were the key maybe credentials of the venue, such as a private key associated with the venue's public key infrastructure (PKI).

The generated visual content, containing the digitally signed verbal information, is then projected onto the speaker's body or clothing by the projection mechanism 720. This process effectively “injects” the digital signature of the speech into the actual visual environment, creating a tamper-evident and authenticatable record of the speaker's statements as described above with reference to the content authenticity mobile devices 100.

As a result, anyone capturing video or images of the speaker at the event will inadvertently record the projected visual content along with the speaker. This visual content serves as a verifiable and tamper-evident digital signature of the speaker's statements, making it difficult for anyone to falsely claim that the speaker said something different or to create a fake video of the event with altered speech.

The venue authenticity device 700 continuously updates the projected visual content to reflect the speaker's ongoing speech, ensuring that the digital signature remains synchronized with the verbal information throughout the event. The processing unit 730 may also incorporate additional authentication data into the visual content, such as timestamps, location information, or event-specific identifiers, to further enhance the integrity and verifiability of the digital signature.

To verify the authenticity of the speaker's statements, anyone can capture the video or images containing the projected visual content and submit them to a verification system. The verification system extracts the digital signature from the visual content and validates it using the venue's public key, for instance as described with reference to decoding content documenting the content authenticity mobile devices 100. If the digital signature is valid, the verification system can confirm that the speaker's statements, as captured in the video or images, are authentic and have not been tampered with.

The venue authenticity device 700 does not require the speaker to actively participate in the authentication process or carry any special devices and ensures that the digital signature is directly embedded into the visual environment, making it an integral part of any recording or capture of the event. This provides a high level of tamper-evidence and verifiability, as the digital signature is cryptographically bound to the speaker's statements and the venue's credentials. For example, the system 266 maybe operated by a party which is not related to the speaker, an entity that provides authentication service to content recorded the venue. This allows a speaker and/or any other third party to use the services provided by the system 266 for signing content or for content authentication. Optionally, the system 266 is provided as a service which is operated when billing via a billing service is completed, either for the signing and/or for the authentication.

The venue authenticity device 700 can be utilized in various settings, such as public speeches, conferences, legal proceedings, or any other event where the authenticity and integrity of a speaker's statements are of critical importance. It offers a powerful tool for venues and event organizers to protect the credibility of their speakers and prevent the spread of misinformation or manipulated media.

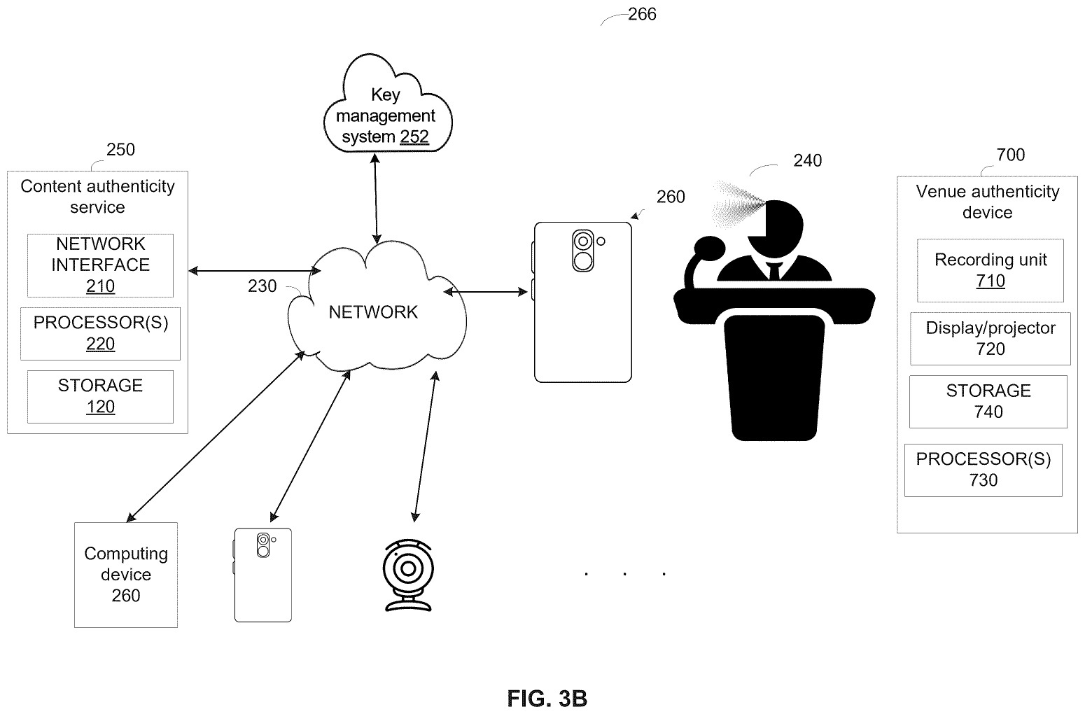

Reference is made to FIG. 4 that illustrates a method 294 for digitally signing content using a content authenticity mobile device 100, according to an embodiment of the present invention. The method 294 begins at step 296, where the sensor 110 of the content authenticity mobile device 100 records the media signal 140 originated from the speaker 150 who is expressing verbal information in a language. At step 297, a processor 130 of the content authenticity mobile device 100 or a network service connected thereto generates the visual content 160 by signing the media signal 140 using at least a unique key (e.g. private key of the device) and a recording time of the media signal 140. The recording time may be obtained from a clock module (not shown) of the content authenticity mobile device 100 or from an external source via a network interface (not shown). The integration of the media signal 140 and the recording time may involve various techniques, such as encoding the recording time as a watermark or steganographic message within the media signal 140, or creating a visual representation that combines the waveform or spectrogram of the media signal 140 with a representation of the recording time or as described above.

At step 298, the processor 130 instructs the display 120 of the content authenticity mobile device 100 to render the visual content 160. The rendering of the visual content 160 on the display 120 effectively digitally signs a content that visually documents the speaker 150 expressing the verbal information, as well as the display 120 itself. As described above, the digital signature created by rendering the visual content 160 on the display 120 serves as a tamper-evident seal that authenticates the origin and integrity of the content captured by the content authenticity mobile device 100. The visual content 160, which is encodes the media signal 140 and the recording time, uniquely identifies the specific moment in time when the media signal 140 was recorded and ties it to the content authenticity mobile device 100 that captured it.

The rendering of the visual content 160 on the display 120 also creates a visual record of the content authenticity mobile device 100 itself, which can be used to verify the authenticity of the device and its role in the digital signing process. By including the display 120 in the digitally signed content, the method 294 provides an additional layer of authentication and tamper-evidence, making it more difficult for an attacker to falsify or manipulate the recorded content without detection.

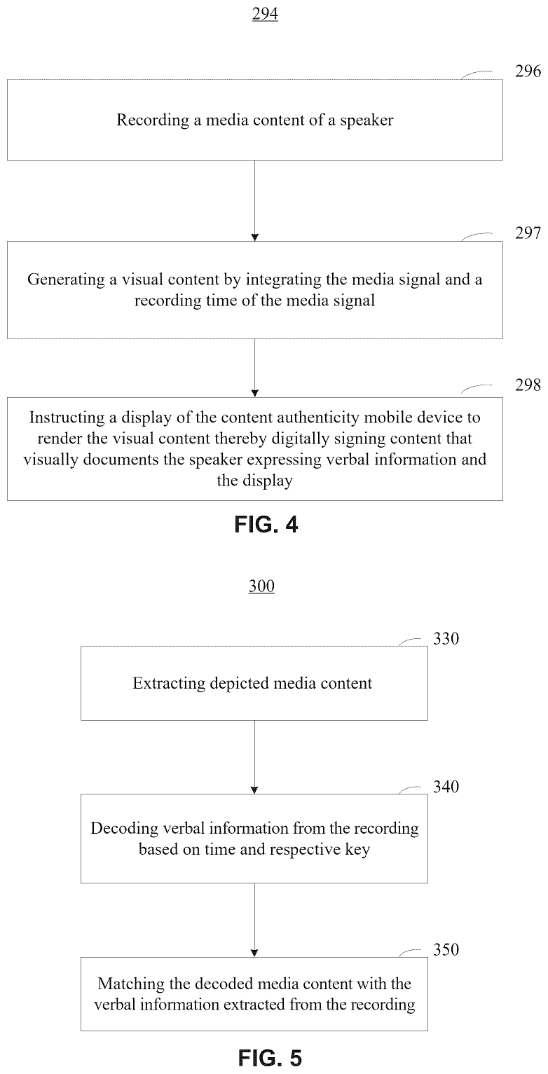

Reference is also made to FIG. 5 which illustrates a method 300 for authenticating media content that documents content depicting the content authenticity mobile device 100 described in FIG. 1. The method 300 may be performed by the system 200 described in FIG. 2 or any other suitable computing device.

The method 300 begins at step 310, where a recording 230 imaging a speaker 150 and a content authenticity mobile device 100 in proximity to the speaker 150 is received. The recording 230 may be received via the network interface 210 or any other suitable input device, such as a camera or microphone.

At 320, verbal information 240 expressed by the speaker 150 in a language is extracted from the recording. This extraction may be performed using audio analysis techniques, such as speech recognition, to convert the speech in the recording to text or other formats suitable for comparison. This allows the verbal information expressed by the speaker to be extracted from the recording in a format suitable for comparison with the decoded media content. The extraction may include appliance of speech recognition to convert the media signal to Mel-Frequency Cepstral Coefficients (MFCC) with time slices corresponding to human speech. MFCCs are a compact representation of the short-term power spectrum of a sound, and are commonly used as features in speech recognition systems. By converting the media signal to MFCCs, the verbal information can be efficiently extracted and compared with the decoded media. The speech recognition may alternatively based on Perceptual Linear Prediction (PLP) to analyze the speech signal. Optionally audio analysis involves techniques such as speech recognition, speaker diarization, or keyword spotting to identify and extract the relevant verbal content from the audio track of the recording.

At 330, media content 160 displayed on the display 120 of the content authenticity mobile device 100 is extracted from the recording. This extraction may be performed using image analysis techniques, such machine vision, to identify and isolate the displayed content from the rest of the recording 230.

At 340, the extracted media content 160 is decoded based on a recording time of the recording 230 and a key associated with the key used for encryption, for instance a public key. This decoding process may involve using the recording time to retrieve a corresponding timestamped key 170 that was used by the content authenticity mobile device 100 to generate the displayed media content 160. The timestamped key 170 may be retrieved from a database or other storage medium that associates timestamped keys with their corresponding recording times.

At 350, the recording 230 is authenticated by matching the extracted verbal information 240 with the decoded media content 160. This matching process may involve comparing the text or other format of the verbal information 240 with the decoded media content 160 to determine if they are consistent.

Optionally, a more granular matching is held for enabling the identification of specific segments or time increments within the recording where the extracted verbal information does not match the decoded media content. In such a process, the recording maybe analyzed in discrete time increments, such as second-by-second or frame-by-frame. This allows for a more precise and localized comparison of the verbal information and the decoded media content. This involves comparing the extracted verbal information with the decoded media content for each time increment, enabling the identification of any mismatches or discrepancies at a granular level.

Now, the specific time increments where mismatches between the extracted verbal information and the decoded media content are detected is identified. These mismatches could indicate potential tampering, editing, or manipulation of the recording at those specific points.

Finally, an authentication output that provides an overall assessment of the recording's authenticity, while also flagging the specific time increments where mismatches were identified, maybe generated. This an authentication output, for instance a report, may include timestamps, descriptions of the mismatches, and other relevant metadata or contextual information.

The authentication process may involve additional steps or techniques, such as comparing the time and location of the recording 230 with the time and location encoded in the media content 160, or analyzing the movement of the speaker 150 in the recording 230 as described above to ensure it matches any movement data encoded in the media content 160.

When the extracted verbal information 240 and decoded media content 160 match, the recording 230 is considered authenticated, indicating that the content of the recording 230 has not been altered or fabricated since it was originally captured. When the information does not match, the recording 230 is considered unauthenticated and may be flagged for further review or rejection.

The method 300 provides a simple and efficient way to authenticate media recordings by leveraging the content authenticity mobile device 100 to create a unique, tamper-proof digital signature that can be verified against the content of the recording itself. This method can be used in various applications, such as journalism, law enforcement, and social media, to ensure the integrity and origin of media content as described above.

The above-described content authenticity mobile device and method 300 enables a robust and reliable authentication process for the recorded media signal 140 by embedding key and timing, for instance a timestamped key, geographic coordinates, and optionally movement data into the visual content 160 displayed on the device's screen. This visual content 160 serves as a digital signature that can be verified by the authentication system to ensure the authenticity and integrity of the recording.

Optionally, in addition to verifying the authentication data, the system 200 also analyzes the recorded media signal 140 itself to detect any signs of tampering or manipulation. This may involve comparing the audio and video tracks to detect any inconsistencies or anomalies, such as sudden changes in background noise or lighting. The system 200 may also use computer vision techniques to analyze the visual content of the recording, looking for any indications of editing or splicing. For example, the system may use object recognition to detect the presence of the content authenticity mobile device 100 in the recording and to ensure that it remains consistent throughout the recording.

If all of the authentication data and media analysis checks pass, the system considers the recording to be authentic and generates a digital certificate or other authentication token that can be used to verify the authenticity of the recording to third parties. However, if any of the authentication checks fail, the system flags the recording as potentially inauthentic and may initiate further investigation or analysis. This may involve manual review by human experts or more advanced forensic analysis techniques. Overall, the authentication process for the content authenticity mobile device is designed to provide a high level of assurance in the authenticity and integrity of the recorded media signal 140. By combining multiple layers of authentication data with advanced media analysis techniques, the system is able to detect and prevent a wide range of tampering and manipulation attempts, ensuring that the recording can be trusted as a reliable record of the original events.

Reference is now made to an exemplary description of the media signal processing as performed for creating from the captured media signal 140 a visible spatiotemporal changing signature by integrating the media signal 140 and the timestamped key 170.

The content authenticity mobile device 100 or a service receiving the captured media signal 140 employs signal processing techniques to analyse and extract relevant features from the captured media signal 140. These techniques enable the device 100 to generate a rich and detailed representation of the recorded content, which can be used to enhance the authentication process and provide additional context for the recording. For audio signals, speech recognition algorithms may be applied to convert the spoken words into text. This may involve the use of acoustic models, language models, and/or phoneme recognition techniques to accurately transcribe the speech content. The processor 130 may also employ speaker diarization techniques to identify and segment the speech of individual speakers in a multi-person conversation. In addition to speech recognition, the processor 130 may also analyze the audio signal to extract other relevant features, such as voice activity detection (VAD), emotion recognition, or ambient noise classification. These features can provide additional context about the recording environment and the emotional state of the speakers.

For video signals, computer vision techniques may be applied to analyze the visual content of the recording. This may include face detection and recognition to identify the speakers, lip movement analysis to synchronize the audio and video tracks, or object recognition to identify relevant objects or scenes in the video. Motion analysis techniques, such as optical flow or motion tracking, may be applied to characterize the movement of the speakers or objects in the video. This motion data can be used to verify the consistency of the recording and to detect any potential tampering or manipulation.

In addition to audio and video analysis, the processor 130 may also incorporate data from other sensors, such as the movement sensor 450 or the location module 430, to provide a more comprehensive analysis of the recording context as described above. For example, the movement data from the accelerometer or gyroscope can be used to detect camera shake or sudden movements, while the location data can be used to verify the geographical context of the recording.

The results of the media signal processing are used to generate a set of metadata that describes the relevant features and characteristics of the recording. This metadata is associated with the recorded media signal 140 and the corresponding key and timing, for instance a timestamped key, and is used by the authentication system to verify the authenticity and integrity of the recording.

Optionally, machine learning techniques, such as deep learning or neural networks, are applied to continuously improve its media signal processing capabilities over time. By training on a large dataset of authentic and tampered recordings, the device 100 can learn to identify patterns and anomalies that are indicative of manipulation or falsification.

The media signal processing allows creating the visual content 160 which serves as a digital signature that authenticates the recorded media signal 140 and links it to a specific time and device. Encoding and/or steganography techniques maybe used to embed the timestamped key 170 into the media signal 140. For video signals, the processor 130 may use video steganography techniques, such as least significant bit (LSB) substitution or discrete cosine transform (DCT) based embedding. These techniques modify pixel values or transform coefficients of video frames to embed the key 170 without significantly affecting the visual quality of the video. In addition to the timestamped key, the processor 130 may also integrate other authentication data into the visual content 160, such as the geographic coordinates of the device location, device orientation and motion data from the movement sensor, or a visual representation of the audio waveform or spectrogram.

It is expected that during the life of a patent maturing from this application many relevant sensors and recording formats will be developed and the scope of the respective terms is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Reference is now made to the following examples, which together with the above descriptions illustrate some embodiments of the invention in a non limiting fashion.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A content authenticity mobile device, comprising:
a sensor configured to record a media signal originated from a speaker who is expressing verbal information in a language;
a display; and
a processor configured to:
generate visual content by signing the media signal with a key and a recording time of the media signal; and
instruct the display to render the visual content, thereby digitally signing the content that visually documents the speaker expressing the verbal information.

2. The content authenticity mobile device of claim 1, further comprising a network interface configured to acquire the timestamped key via a network.

3. The content authenticity mobile device of claim 1, wherein the processor generates the visual content also based on geographic coordinates of the environment.

4. The content authenticity mobile device of claim 3, wherein the geographic coordinates are received as a one-time code from a location module.

5. The content authenticity mobile device of claim 1, wherein the sensor is a microphone and the media signal is an audio signal.

6. The content authenticity mobile device of claim 1, wherein the sensor is a camera and the media signal is a video signal documenting lips movement of the speaker.

7. The content authenticity mobile device of claim 1, further comprising an a movement sensor configured to record movement of the speaker while the speaker expresses the verbal information; wherein the visual content is generated based on the movement of the speaker.

8. The content authenticity mobile device of claim 1, wherein the movement sensor is selected from a group consisting of an accelerometer, an inertial measurement unit (IMU), a magnetometer, and a gyroscope.

9. The content authenticity mobile device of claim 1, wherein the content authenticity mobile device is a smartphone device.

10. A method for authenticating media content, comprising:
receiving a recording imaging a speaker and a content authenticity mobile device in proximity to the speaker and a recording time of the recording;
extracting from the recording:
verbal information expressed by the speaker in a language, and
media content displayed on a display of the content authenticity mobile device;
decoding the media content based on the recording time;
authenticating the recording by matching between the verbal information and the decoded media content.

11. The method of claim 10, wherein the extracting or the authenticating comprises applying speech recognition to convert the media signal to text.

12. The method of claim 10, wherein the extracting comprises applying speech recognition to convert the media signal to Mel-Frequency cepstral coefficients (MCCC) with time slices corresponding a human speech.

13. The method of claim 10, wherein the speech recognition is based on perceptual Linear Prediction (PLP).

14. The method of claim 10, wherein the verbal information is extracted from the recording by audio analysis.

15. The method of claim 10, wherein the verbal information is extracted from the recording by image analysis.

16. The method of claim 10, further comprising using the recording time to acquire a timestamped key.

17. The method of claim 16, wherein the timestamped key is used for decoding the displayed media content.

18. The method of claim 10, further comprising:
analyzing the recording in discrete time increments;
for each time increment, comparing the verbal information extracted from the recording with the decoded media content displayed on the content authenticity mobile device;
identifying one or more specific time increments where there is a mismatch between the extracted verbal information and the decoded media content; and
generating an authentication report indicating the overall authenticity of the recording and flagging the specific time increments where mismatches were identified as potentially inauthentic.

19. A system for authenticating media content, comprising:
a network interface for receiving a recording that includes:
depiction of a speaker and a content authenticity mobile device in proximity thereto, and
a recording time; and
one or more processors configured to execute code for:
extracting from the recording:
verbal information expressed by the speaker in a language,
media content displayed on a display of the content authenticity mobile device,
decoding the extracted media content based on the recording time, and
authenticating the recording by matching the extracted verbal information with the decoded media content displayed on the content authenticity mobile device.

20. A method for digitally signing content using a content authenticity mobile device, the method comprising:
recording, by a sensor of the content authenticity mobile device, a media signal originated from a speaker who is expressing verbal information in a language;
generating, by the processor, visual content by signing the media signal with a recording time of the media signal;
instructing, by the processor, a display of the content authenticity mobile device to render the visual content thereby digitally signing content that visually documents the speaker expressing the verbal information and the display.

21. A digital signature service for authenticating a speaker's statements at a venue, comprising:
a recording unit configured to capture verbal information expressed by the speaker;
a processing unit configured to:
extract the verbal information from the captured audio signal,
generate visual content by integrating the extracted verbal information with a digital signature associated with the venue, and
a projection mechanism configured to project the generated visual content onto the speaker's body or clothing, thereby embedding the digital signature of the speaker's statements into the visual environment.

22. The digital signature service of claim 21, wherein the digital signature is created using a private key associated with the venue's public key infrastructure (PKI).

23. The digital signature service of claim 21, wherein the visual content comprises at least one of QR codes or time-modulated signals.

24. The digital signature service of claim 21, wherein the processing unit is further configured to incorporate additional authentication data into the visual content, the additional authentication data comprising at least one of timestamps, location information, or event-specific identifiers.

25. The digital signature service of claim 21, further comprising a verification system configured to: receive captured video or images containing the projected visual content, extract the digital signature from the visual content, and validate the digital signature using a public key associated with the venue.

26. The digital signature service of claim 25, wherein the verification system is further configured to confirm the authenticity of the speaker's statements if the digital signature is valid.
